(19) United States
(12) Patent Application Publication
(10) Pub. No.: US 2003/0084019 A1
(43) Pub. Date: May 1, 2003

(54) Process for lifetime tracking of serialized parts

(75) Inventor: Donald E. Woodmansee, Simpsonville, SC (US)

Correspondence Address: Patrick R. Scanlon, Esq., Pierce Atwood, One Monument Square, Portland, ME, 04101, US

(73) Assignee: General Electric Company

(21) Appl. No.: 10/021,101

(22) Filed: Oct. 30, 2001

(51) Int. Cl. G06F 7/00

(52) U.S. Cl. 707/1

(57) ABSTRACT

A method for tracking part histories for a set of serialized parts used in one or more gas turbine engines uses a database of part status data. The database is updated whenever a service outage occurs for one or more of the engines. Specifically, for each part in the database, the part status at the end of the service outage is entered into the database.

### BACKGROUND OF THE INVENTION

This invention relates generally to tracking large sets of serialized parts and more particularly to using a relational database in conjunction with spreadsheet tools to track parts.

Mechanical systems such as gas turbine engines can comprise many parts. A typical gas turbine engine includes a compressor that provides pressurized air to a combustion section where the pressurized air is mixed with fuel and ignited for generating hot combustion gases. These gases flow downstream through a transition piece to a multi-stage turbine. Each turbine stage includes a stationary turbine nozzle and a plurality of circumferentially spaced apart blades or buckets extending radially outwardly from a wheel that is fastened to a shaft for rotation about the centerline axis of the engine. The hot gases expand against the turbine buckets causing the wheel to rotate. This in turn rotates the shaft that is connected to the compressor and may be also connected to load equipment such as an electric generator or a propeller. Thus, the turbine extracts energy from the hot gases to drive the compressor and provide useful work such as generating electricity or propelling an aircraft in flight.

Gas turbines are routinely subjected to various maintenance operations as part of their normal operation. Many gas turbine parts, such as combustor liners, liner caps, endcover assemblies, transition pieces, turbine buckets, nozzle segments, etc., are exposed to a high temperature, corrosive gas stream during operation that limits their effective service life. Consequently, these parts, which are referred to as life-limited parts, periodically need to be repaired or replaced to maintain safe, efficient operation. During regularly scheduled service outages, life-limited parts are dispositioned based on their remaining life. Parts with sufficient remaining life are put back into service after any necessary repairs; parts without remaining life need to be replaced. Remaining life can be reliably estimated for parts for which an entire part history (i.e., a history of the part's operating exposures, repairs, modifications, etc.) is available. However, because such part histories are rarely available, life-limited parts are normally subjected to time-consuming and expensive non-destructive examination (NDE) techniques to determine remaining life.

Tracking part histories for serialized parts is extremely difficult because there is not a convenient, practical system for following such parts. Tracking of individual, serialized parts has most commonly been employed only during the manufacturing process. For example, castings of gas turbine nozzle segments are followed throughout manufacture by serial numbers that are initially cast into their first structures. However, it is common for the nozzle segments to be tracked only as initial sets (for a particular gas turbine engine, for example) rather than as individual serialized parts. While it is common to record the serial number of a part when it is discarded, the complete part history of the part after leaving the factory is usually unknown. The tracking of parts as complete sets is more easily handled, but the process falls down when individual members of sets are withdrawn for special treatment such as repair or modification. In these cases, set-based tracking becomes confounded by part histories within a set becoming non-uniform. Over several use and repair cycles, the concept of a common set history becomes compromised, and the management of the parts reverts completely to conducting detailed, non-destructive examination of the parts to determine remaining life.

Accordingly, it would be desirable to have a convenient, practical process for tracking the entire part histories of individual, serialized parts for use in predicting part reliabilities.

### BRIEF SUMMARY OF THE INVENTION

The above-mentioned need is met by the present invention, which provides a method for tracking part histories for a set of serialized parts used in one or more gas turbine engines. The method uses a database of part status data. The database is updated whenever a service outage occurs for one or more of the engines. Specifically, for each part in the database, the part status at the end of the service outage is entered into the database.

The present invention and its advantages over the prior art will become apparent upon reading the following detailed description and the appended claims with reference to the accompanying drawings.

### BRIEF DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a flow chart that illustrates a part tracking process of the present invention used in connection with the service and repair workflows of a gas turbine engine.

FIG. 2 shows, in spreadsheet form, an exemplary Configuration Table from a part life database.

FIG. 3 shows a continuation of the Configuration Table of FIG. 2.

FIG. 4 shows, in spreadsheet form, an alternative form of an exemplary Configuration Table from a part life database.

FIG. 5 shows a continuation of the Configuration Table of FIG. 4.

### DETAILED DESCRIPTION OF THE INVENTION

The present invention includes a process for tracking the entire history of individualized, serialized parts. The process utilizes a relational database, referred to herein as the part life database, in conjunction with spreadsheet tools to simplify and make practical the tracking of parts over their lifetimes. The part life database comprises part status data contained in multiple tables that can be linked by keys. For example, when tracking gas turbine parts, the database tables can be linked by keys such as engine serial number, part serial number and outage start date for an engine. The tables are otherwise independent and orthogonal. As used herein, “orthogonal” indicates that new data need only be entered into one of the tables in one place, and such new data can be linked to the other tables using a relational database engine.

In one embodiment, the part life database includes a Configuration Table, an Operations Table, a Part Condition Table, and a Financial Table. The Configuration Table provides, for each part, the engine serial number, the specific location of the part during engine service, as well as the part functional status when not in service (e.g., repair job number, whether scrapped, etc. The Operations Table provides, for each engine, the time increment since the last service outage, the number of integer counts of starts, trips, fast ramps, etc., and the time-based integrals of firing temperature levels above or below design point. The Operations Table, per se, identifies only engines, not parts, and is therefore orthogonal to the Configuration Table. The Part Condition Table provides, for each part, the part condition description at each dated engine outage where the part is inspected. Since this table does not contain information on configuration or engine operations, it is also orthogonal to the previous two tables. The Financial Table provides, for each part, a listing of all expense tracking numbers and their expenses, costs, etc., in field service, shop service and part replacement service categories.

The part tracking process uses a timing procedure for recording part status data. The timing procedure prescribes service outage and operation periods at a particular power plant site that minimizes the stipulation of event dates and thereby simplifies compilations of site history to outage dates only. In gas turbine engines, as in most mechanical systems, the only time that parts can be removed and replaced is when the engine is not running, i.e., during an engine service outage. To avoid use of multiple times or dates for each single engine event (shutdown, part removal, part replacement, engine restart), a single date is selected to cover the dating for all events associated with a particular service outage. The date chosen in this process is the date that the engine is shut down for service, although it should be noted that any pertinent date could be used for this purpose.

Moreover, most multi-engine sites (i.e., power plant sites running multiple gas turbine engines) are usually broken into “blocks” of engines that are linked by common output power equipment. The engines in each block are most often shut down for repair together to facilitate repair logistics, such as hiring contract labor and utilizing laydown space. Where two or more gas turbine engines are shut down for such shared outages, the shutdown date for the first engine is chosen as the outage date for all of the engines. This simplifies accounting for time in the part life database because the actual hours of engine operation are not computed from these outage dates but rather from incremental hours data in the Operations Table. Thus, not only are the specific dates of part removal, part replacement and engine restart not needed in the part life database, but the overlapping dates of engine outages when parts might be swapped between engines, for example, are automatically recognized by the same outage date. If the engine outages do not overlap in time, then separate outage dates would be cited for each engine.

If the engine outage dates for a multi-engine site are listed chronologically, then the time between any two consecutive outage dates is described as an “operating period,” during which time all engines on the site are either operating or deemed to be available for operation. This approach is useful because parts cannot be removed, swapped or replaced anywhere on the site during these operating periods. As mentioned above, the individual records of actual engine operations (hours, starts, trips, etc.) come from the Operations Table, which also recognizes these same operating periods in its structure even while different engines will have differing run hours during a given operating period. It has been found convenient to label site outage and operating periods serially with integers, with the first engine startup shown as outage zero, thereby beginning the Operating Period zero. Note that individual engine outages will occur as some subset of the site outages, since the site outages are defined as dates when any engine is on outage.

In addition, the process tabulates the entire configuration history of a serialized part within a single database record, using the above timing procedure combined with a shorthand protocol for describing the location and/or disposition of a part in each operation period from initial commissioning to final scrap. The process uses spreadsheet functions to count numbers of parts in any component subset listings with similar dispositions such as “new,” “scrap,” etc., and graph these results for any of several reasons, such as to perform a site spare parts pool analysis. The process also uses macros to transfer spreadsheet output files of component subset information to external statistical packages whose own macros generate further graphical information.

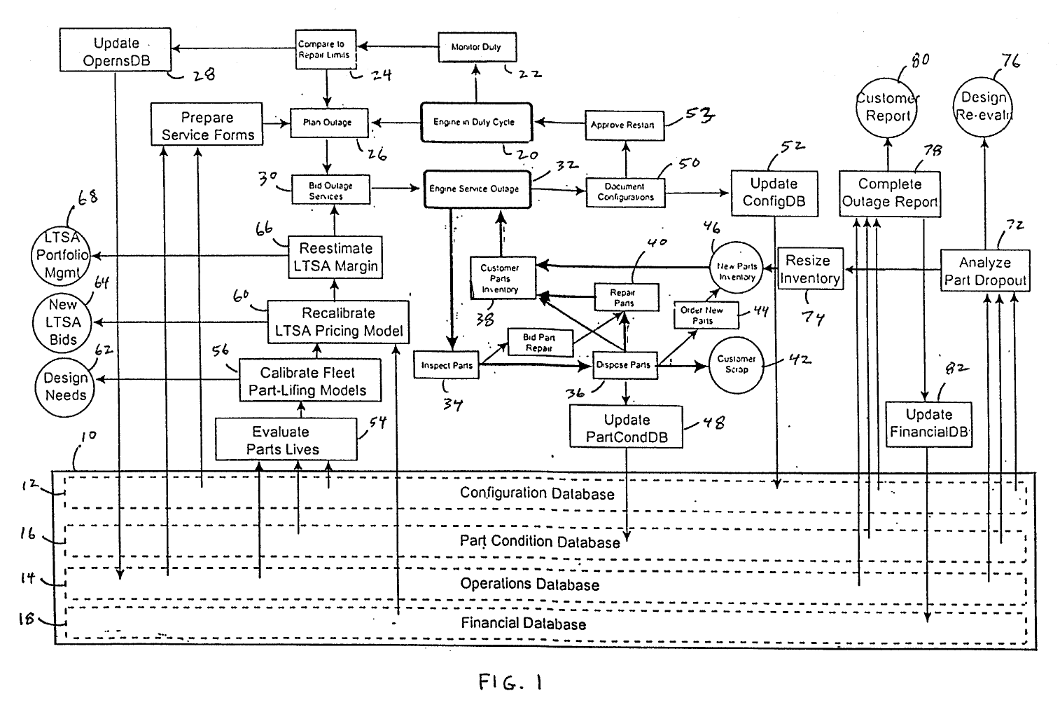

Referring to FIG. 1, the part tracking process is described in connection with a flowchart showing the service and repair workflows of a gas turbine engine. While described herein in connection with gas turbine parts, it should be noted that the present invention is not limited to such parts and can be used with a wide variety of serialized parts. The process utilizes a part life database 10 that includes a Configuration Table 12, a Operations Table 14, a Part Condition Table 16, and a Financial Table 18, as described above.

In FIG. 1, block 20 represents a gas turbine engine in a duty cycle or operating period. During an operating period, engine operation is monitored by onsite monitors, such a temperature gauges, pressure sensors and the like, as shown at block 22. The monitoring data is compared to prescribed repair limits at block 24. From this comparison, the engine operator is able to plan the next service outage at block 26. That is, the operator uses the data to determine when the next service outage should be and what services should be carried out during the outage. The operator also uses this data to update the Operations Table 14 as represented at block 28. Specifically, data relating to the time increment since the last service outage, the number of integer counts of starts, trips, fast ramps, etc., and the time-based integrals of firing temperature levels above or below design point is entered into the Operations Table 14 for each part in the engine (or engines) being monitored. Data entered into the Operations Table 14 includes values of running accumulations of run hours and transient events. Run hours would include (for example) total fired hours, oil fired hours, and peak fired hours. Transient events would be integer values of fired starts, emergency trips, and rapid starts. There are many ways to characterize engine operations, and the above set of data is just an example.

At block 30, the operator bids the desired outage services, as determined at block 26, and then shuts down the engine at block 32 for the service outage. During the service outage, life-limited parts are removed and inspected as shown at block 34. The removed parts are dispositioned at block 36 in accordance with their inspection and/or a remaining life evaluation based on information taken from the part life database 10. That is, parts that are determined to be reusable are returned to the operator's on-site parts inventory as indicated at block 38. Parts that are in need of repair are sent to an appropriate repair facility to be repaired, as indicated at block 40. The subsequently repaired parts are then returned to the operator's inventory at block 38. Parts that are neither reusable nor repairable are scrapped as shown at block 42. The scrapping of parts triggers an order of new parts at block 44 from the manufacturer's new parts inventory, as represented by block 46. The new parts from the manufacturer are entered to the operator's inventory at block 38. As indicated at block 48, the operator updates the Part Condition Table 16 based on the condition of each part as determined at block 36. The part condition data is entered by continuous measurements of specific conditions whose values are requested for individual part areas. A given part may have several sets of dated inspection data depending on how many times the part was removed from service and inspected prior to a decision to making repairs or otherwise dispositioning the part.

The parts removed from the engine during the engine outage at block 32 are replaced with replacement parts taken from the operator's inventory at block 38. The operator documents the configurations of the replacement parts at block 50 and uses the new configurations to update the Configuration Table 12 at block 52. That is, for each replacement part, the engine serial number, the specific location of the part during the upcoming operating period, the part status, and/or any service tracking number is entered into the Configuration Table 12. Once all of the planned service is completed, the operator approves engine restart at block 53, and the engine returns to service as represented at block 20.

As mentioned above, the part life database 10 is used to track the entire history of the parts recorded therein. At block 54, the operator uses data from the Configuration Table 12, the Operations Table 14 and the Part Condition Table 16 to evaluate remaining life of each part without utilizing reliability techniques. The remaining lives of a part set can be predicted using well-established reliability techniques including the use of Weibull distribution predictions. In such techniques, the number of parts that fail (e.g., are scrapped) are related to the engine exposures the parts have seen. These exposures are expressed either as cumulative running hours or cumulative events. The remaining life evaluation can be used to disposition parts at block 36. The remaining life evaluation can also be used to calibrate fleet part-life models at block 56 and, together with financial data from the Financial Table 18, to recalibrate pricing models for customer long-term services agreements (LTSAs) at block 60. The fleet part-life models are useful in meeting design needs at block 62. The recalibrated LTSA pricing models are used for new LTSA bids at block 64 and to re-estimate LTSA margin at block 66. This is beneficial in LTSA portfolio management at block 68 as well as bidding desired outage services at block 30.

The part life database 10 is used in other ways to track the entire history of the parts recorded therein. For instance, at block 70, the operator is able to take data from the Configuration Table 12 and the Operations Table 14 to prepare pertinent service forms. These service forms are utilized in planning engine service outages at block 26. For example, the service forms require both the specification of part serial numbers removed from various engine positions, and those repaired- or new-part serial numbers that are installed. The service forms can be preloaded with database information on serial numbers that were installed in the engine, and the field engineer simply needs to validate that those “removed” numbers are correct. Similarly, the serial numbers of repaired or new parts available for installation can be made as dropdown menu entries for the “installed” fields. In each case, the practical benefit is that the serial numbers do not need to be transcribed by the field engineer, thereby increasing his productivity and reducing the chances of generating transcription errors.

At block 72, the manufacturer can use data from the Configuration Table 12, the Operations Table 14 and the Part Condition Table 16 to analyze part dropout rate. This analysis can be used to resize the manufacturer's inventory at block 74 if necessary and to re-evaluate part design at block 76 for part's having a high dropout rate. The manufacturer can also use data from the Configuration Table 12, the Operations Table 14 and the Part Condition Table 16 to complete an outage report at block 78. The outage report is provided to the customer at block 80 and used to update the Financial Table 18 at block 82. The report submitted to the customer would contain all the engine operations- and part configuration-data recorded by the field engineer. This data would be taken from tables in the part life database. More detailed information on the number of service intervals each part has experienced can also be provided to the customer, if desired.

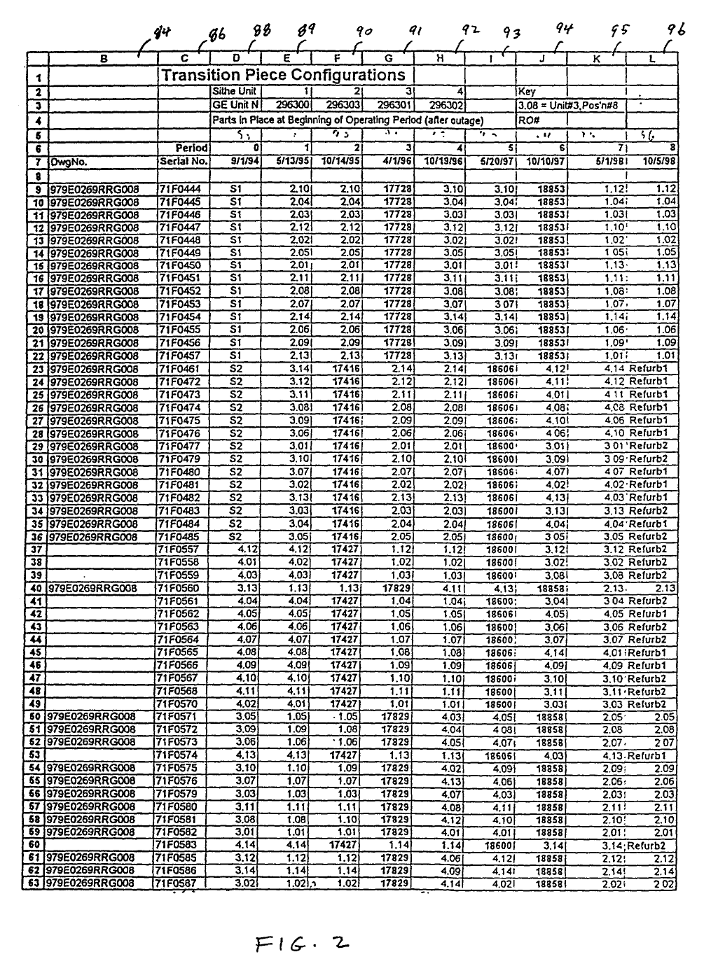

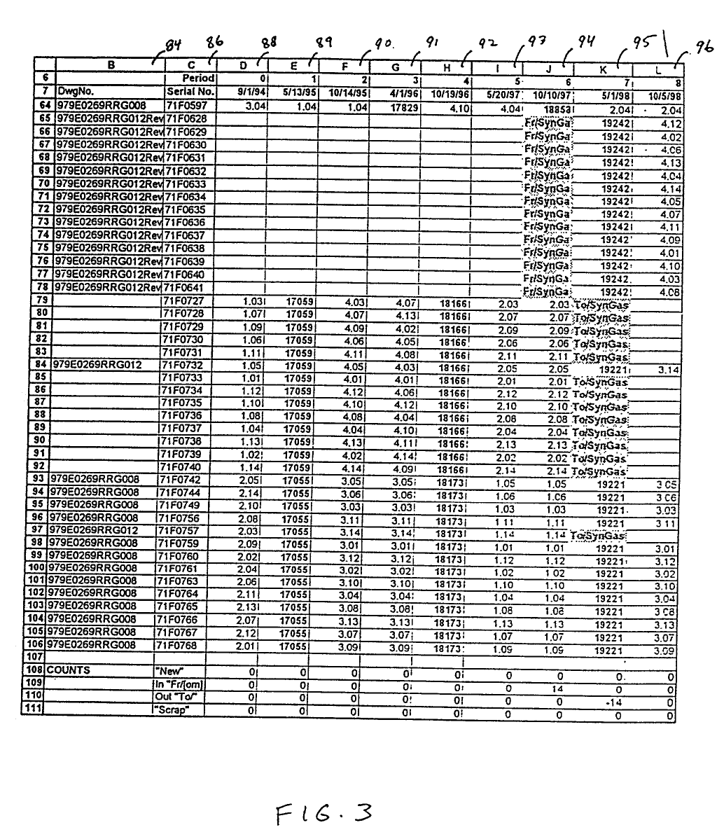

FIGS. 2 and 3 show, in spreadsheet form, an exemplary Configuration Table from a part life database. In particular, FIGS. 2 and 3 show a Configuration Table in which the complete part lives of a subset of transition pieces is displayed. It should be noted that transition pieces are used here only by way of example and that the present invention is applicable to a wide range of part types. The Configuration Table maps the entire lifetime record for each part in a single record, the records being shown in FIGS. 2 and 3 as rows in the table (although each record alternatively could be configured as a column). The Configuration Table includes a number of columns, including a Drawing No. column 84, a Serial No. column 86, and a series of Operating Period columns 88-96. Thus, for each record or part, the appropriate drawing number and serial number are entered in the Drawing No. column 84 and the Serial No. column 86, respectively. The Operating Period columns 88-96 are identified by the date associated with a particular service outage. As mentioned above, this date is generally the date that the engine is shut down for service, although it should be noted that any pertinent date (such as engine restart date) could be used for this purpose. The first Operating Period column 88 is identified with the date of the first engine startup, which is denoted as “outage zero.” The remaining Operating Period columns 89-96 are identified by subsequent dates that the engine is shut down for service. As discussed previously, the time between any two consecutive outage dates is described as an “operating period.” The time between first Operating Period column 88 and second Operating Period column 89 is denoted “Operating Period zero,” the time between second Operating Period column 89 and third Operating Period column 90 is denoted “Operating Period one,” and so on up to “Operating Period eight.” Addition columns for subsequent operating periods can be added as needed.

In each row corresponding to a particular part, data representing the status of that part at the end of each service outage, and thus during each corresponding operation period, is entered in the appropriate column. That is, the status of the part having serial number 71F0444 during Operating Period zero is entered in the datafield corresponding to the row for that part (row 9) and the first Operating Period column 88. The status of the part serial number 71F0444 during Operating Period one is entered in the datafield corresponding to the row for that part (row 9) and the second Operating Period column 89.

The concept of operating periods enables use of a shorthand description (referred to herein as descriptive formats or descriptors) for part status. One such descriptive format comprises a number with a decimal fraction; the number represents the engine unit number at the site, and the decimal describes where in the unit the part was installed. For example, in FIGS. 2 and 3, the decimal fraction 3.08 indicates that the transition piece is installed in position number 8 in engine unit number 3. For an extended database with many sites, the site unit number could alternatively be the manufacturer's engine serial number. In this way, the engine serial number would be a key to the manufacturer's customer database, which would contain both engine-specific and site-specific information.

Another feature of the present invention is that other, non-numeric descriptors can be displayed in the same table to show part history. For example, the text “S1” in the first Operating Period column 88 is used to indicate that this part was onsite and ready to be used as a part of the first set of spare transition pieces. Similarly, the text “S2” is used to indicate that the part was onsite and ready to be used as a part of the second set of spare transition pieces. Another possibility is the use of refurbishment repair order numbers as descriptors that provide links to inspection reports containing part conditions as well as to financial reports describing expenses associated with the refurbishment. Here, 5-digit repair order numbers, such as those shown in Operating Period columns 89-95, are shown in bold. Text can be used to describe other refurbishments listed as “Refurb” (see Operating Period column 96) before a repair order number is either assigned or known.

Text descriptors can also be used to show the transfer of parts into or out of the site pool using prefixes “fr/” and “to/”, respectively. For example, the datafield entry “fr/SynGa” in Operating Period column 94 represents that the part has been transferred into the site pool from the site known as “SynGa.” The datafield entry “to/SynGas” in Operating Period column 95 represents that the part has been transferred from the site pool to the site known as “SynGas.” Other possible text descriptors include “scrap” (indicating that the part has been discarded or scrapped) and “new” (indicating that the part is a new part received from the manufacturer's new parts inventory). It should be noted that a wide variety of descriptors beyond those noted here could be used with the present invention. The combination of text and numerics in the same field makes the table more practically readable in its raw state.

Commonly available spreadsheet functions can be used to extract both numeric and textual information from this Configuration Table without compromising the readability of the table itself. As an example, in rows 1081-110 of FIG. 3, the results of a “count” function have been implemented to count the number of “new”, “fr/”, “to/”, or “scrap” transition pieces. Once the basic configuration of the data structure is in place, any number of such counts can be performed using whatever descriptors are in the fields, whether numeric or textual. This feature is very valuable in identifying parts that are scrapped in successive operating periods.

One of the features of this data structure is the speed with which construction of sets of parts can be formulated for any operating period in the Configuration Table. In FIGS. 2 and 3, the data has been sorted simply by part serial number in Serial No. column 86. However, it is also possible to sort data by part status within any of the Operating Period columns 88-96. By doing this, the transition pieces will sort into the sets that were installed in the engines and the repair orders for the remaining sets. This is a powerful technique for verifying that sets of parts are complete, and that changes in status are logical based on the set that the part belonged to (at some prior time). As an example, the ability to sort first by scrapped parts and then by part serial number enables the identification that failures in parts were likely due to their being the first cast (i.e., lowest serial numbers) at the vendor foundry before the process became fully steady.

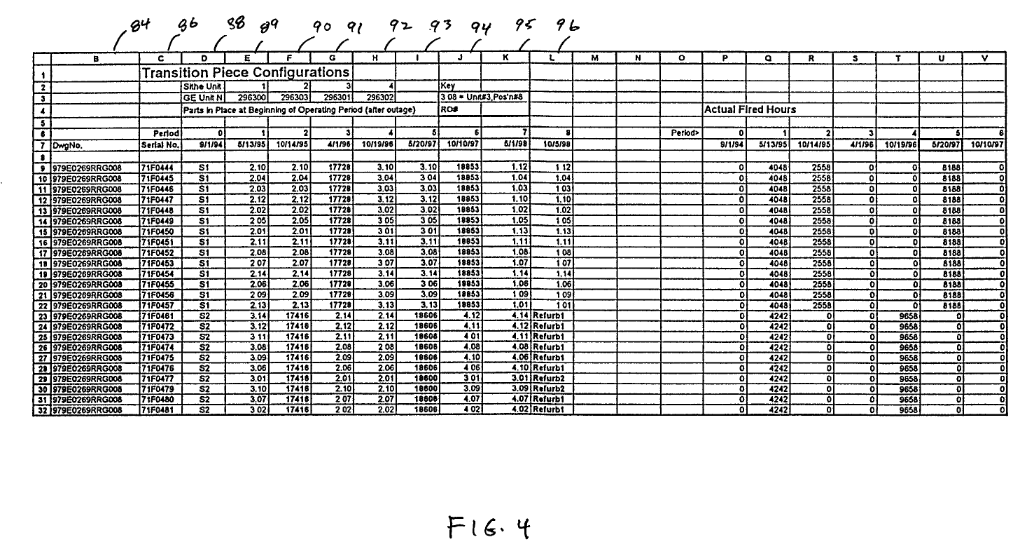

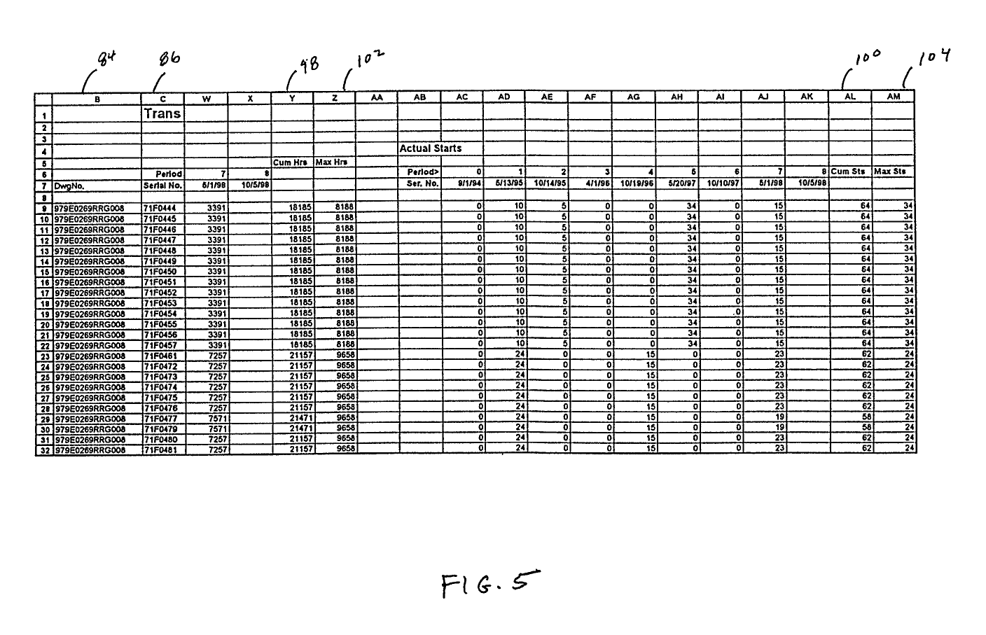

FIGS. 4 and 5 show, in spreadsheet form, an alternative embodiment of the Configuration Table displaying the complete part lives of a subset of transition pieces. In particular, FIGS. 4 and 5 show the same data as FIGS. 2 and 3 but also shows derivative calculations in columns on the right side of the table. This data represents the cumulative exposures of each part using a custom, user-defined function. The function determines for each site operating period, which engine the part was in. It then goes to the appropriate Operations Table elsewhere in the spreadsheet workbook for the part life database and determines the number of hours (or starts) the engine had during that period. The cumulative values in columns 98 and 100 of FIG. 5 are simple summations of these lookup values. The maximum values in columns 102 and 104 of FIG. 5 are simply the maximum values in the separate sets that were accumulated in columns 98 and 100.

The ability to generate these exposures in a spreadsheet format is not only very fast compared to other database engine, it is also more robust because the date fields being examined are not of the uniform type usually required by the databases. This discrimination is done in the spreadsheet using logical functions that decide on inclusion in the hours (or starts) lookup based on whether or not the field value is numeric or textual, and if numeric, the value is in the correct range to be interpreted as configuration shorthand; e.g., 3.08. This capability enables the practical and useful combination of the simple, mixed-type, readable shorthand structure of the data in the Configuration Table with the ability to conduct calculations on only the numeric fields without getting confused or giving error signals.

This Configuration Table format has also been shown to be practical and useful in structuring configuration data for processing by statistical computer application programs beyond the spreadsheet. The summary fired hour exposure data of FIG. 5 can be copied into such a statistical application which can then use its internal functions to generate a histogram of part frequency (number of parts) versus several binned groupings of fired hours. This type of analysis can help to characterize the “age” distribution of the parts as either an entire set or as a subset (e.g., only those parts currently installed).

While specific embodiments of the present invention have been described, it will be apparent to those skilled in the art that various modifications thereto can be made without departing from the spirit and scope of the invention as defined in the appended claims. In particular, there is a plethora of ways to characterize the part exposures in terms of running hours and types of transient events.

What is claimed is:

1. A method for tracking part histories for a set of serialized parts, said method comprising:
providing a database of part status data;
noting when a service outage affecting one or more of said parts occurs; and
for each part in said database, entering the part status at the end of said outage into said database.

2. The method of claim 1 further comprising using part status data to evaluate remaining life for one or more of said parts.

3. The method of claim 1 wherein said database is a relational database comprising multiple tables linked by keys.

4. The method of claim 1 wherein said database uses text and/or numeric descriptors to represent part statuses.

5. The method of claim 1 wherein said part status data is sorted by part serial number.

6. The method of claim 1 wherein said part status data is sorted by part status.

7. The method of claim 1 further comprising calculating cumulative run hours for one or more of said parts.

8. The method of claim 1 further comprising calculating cumulative starts for one or more of said parts.

9. A method for tracking part histories for a set of serialized parts used in one or more gas turbine engines, said method comprising:
providing a database of part status data;
noting an engine outage date associated with a service outage of one or more of said engines; and
for each part in said database, entering the part status at the end of said outage into said database.

10. The method of claim 9 wherein said engine outage date is the date one of said engines is shut down.

11. The method of claim 9 further comprising using part status data to evaluate remaining life for one or more of said parts.

12. The method of claim 9 wherein said database is a relational database comprising multiple tables linked by keys.

13. The method of claim 12 wherein said keys are selected from the group consisting of engine serial number, part serial number and engine outage date.

14. The method of claim 9 wherein said database uses shorthand descriptors to represent part statuses.

15. The method of claim 14 wherein said database uses text descriptors to represent new part status, transferred part status and scrapped part status.

16. The method of claim 14 wherein said database uses numeric descriptors to represent which one of said engines a part is installed in and which position in said engine a part is located.

17. The method of claim 9 wherein said part status data is sorted by part serial number.

18. The method of claim 9 wherein said part status data is sorted by part status.

19. The method of claim 9 further comprising calculating cumulative run hours for one or more of said parts.

20. The method of claim 9 further comprising calculating cumulative starts for one or more of said parts.
